(19) United States
(12) Patent Application Publication
(10) Pub. No.: US 2012/0117456 A1
(43) Pub. Date: May 10, 2012

(54) METHOD AND APPARATUS FOR AUTOMATED INTERFACES

(75) Inventor: Olli Oskari Koskimies, Helsinki (FI)

(73) Assignee: Nokia Corporation, Espoo (FI)

(21) Appl. No.: 12/940,685

(22) Filed: Nov. 5, 2010

(51) Int. Cl. G06F 17/00; G06F 3/048

(52) U.S. Cl. 715/224; 715/234

(57) ABSTRACT

An approach is provided for using scripts to utilize a service. A request specifying one or more tasks of the service with respect to a target object is received. One or more scripts are determined for performing the one or more tasks. It is determined to initiate the one or more scripts to use, at least in part, information associated with the target object to perform the one or more tasks.

### BACKGROUND

Service providers and device manufacturers (e.g., wireless, cellular, etc.) are continually challenged to deliver value and convenience to consumers by, for example, providing compelling network services. Important differentiators in these industries are application and network services. Developers of these services, however, may find it difficult to provide compelling services across a variety of devices. For example, many developers need to write new applications for each device the developers' services are to be utilized on. The technical challenges to creating these applications for a variety of devices can be time consuming. As such, device manufacturers that desire to attract developers to provide services for the manufacturers' devices can benefit from easing the burden to provide services on the respective devices.

### SOME EXAMPLE EMBODIMENTS

Therefore, there is a need for an approach for utilizing scripts to customize services on devices.

According to one embodiment, a method comprises receiving a request specifying one or more tasks of a service with respect to a target object. The method also comprises determining one or more scripts for performing the one or more tasks. The method further comprises determining to initiate the one or more scripts to use, at least in part, information associated with the target object to perform the one or more tasks.

According to another embodiment, an apparatus comprises at least one processor, and at least one memory including computer program code, the at least one memory and the computer program code configured to, with the at least one processor, cause, at least in part, the apparatus to receive a request specifying one or more tasks of a service with respect to a target object. The apparatus is also caused to determine one or more scripts for performing the one or more tasks. The apparatus is further caused to determine to initiate the one or more scripts to use, at least in part, information associated with the target object to perform the one or more tasks.

According to another embodiment, a computer-readable storage medium carries one or more sequences of one or more instructions which, when executed by one or more processors, cause, at least in part, an apparatus to receive a request specifying one or more tasks of a service with respect to a target object. The apparatus is also caused to determine one or more scripts for performing the one or more tasks. The apparatus is further caused to determine to initiate the one or more scripts to use, at least in part, information associated with the target object to perform the one or more tasks.

According to another embodiment, an apparatus comprises means for receiving a request specifying one or more tasks of a service with respect to a target object. The apparatus also comprises means for determining one or more scripts for performing the one or more tasks. The apparatus further comprises means for determining to initiate the one or more scripts to use, at least in part, information associated with the target object to perform the one or more tasks.

Still other aspects, features, and advantages of the invention are readily apparent from the following detailed description, simply by illustrating a number of particular embodiments and implementations, including the best mode contemplated for carrying out the invention. The invention is also capable of other and different embodiments, and its several details can be modified in various obvious respects, all without departing from the spirit and scope of the invention. Accordingly, the drawings and description are to be regarded as illustrative in nature, and not as restrictive.

### BRIEF DESCRIPTION OF THE DRAWINGS

The embodiments of the invention are illustrated by way of example, and not by way of limitation, in the figures of the accompanying drawings:

FIG. 1 is a diagram of a system capable of using scripts to utilize a service, according to one embodiment;

FIG. 2 is a diagram of the components of user equipment, according to one embodiment;

FIG. 3 is a flowchart of a process for using scripts to utilize a service, according to one embodiment;

FIGS. 4-7 are diagrams of user interfaces utilized in the processes of FIG. 3, according to various embodiments;

FIG. 8 is a diagram of hardware that can be used to implement an embodiment of the invention;

FIG. 9 is a diagram of a chip set that can be used to implement an embodiment of the invention; and

FIG. 10 is a diagram of a mobile terminal (e.g., handset) that can be used to implement an embodiment of the invention.

### DESCRIPTION OF SOME EMBODIMENTS

Examples of a method, apparatus, and computer program for using scripts to utilize a service are disclosed. In the following description, for the purposes of explanation, numerous specific details are set forth in order to provide a thorough understanding of the embodiments of the invention. It is apparent, however, to one skilled in the art that the embodiments of the invention may be practiced without these specific details or with an equivalent arrangement. In other instances, well-known structures and devices are shown in block diagram form in order to avoid unnecessarily obscuring the embodiments of the invention.

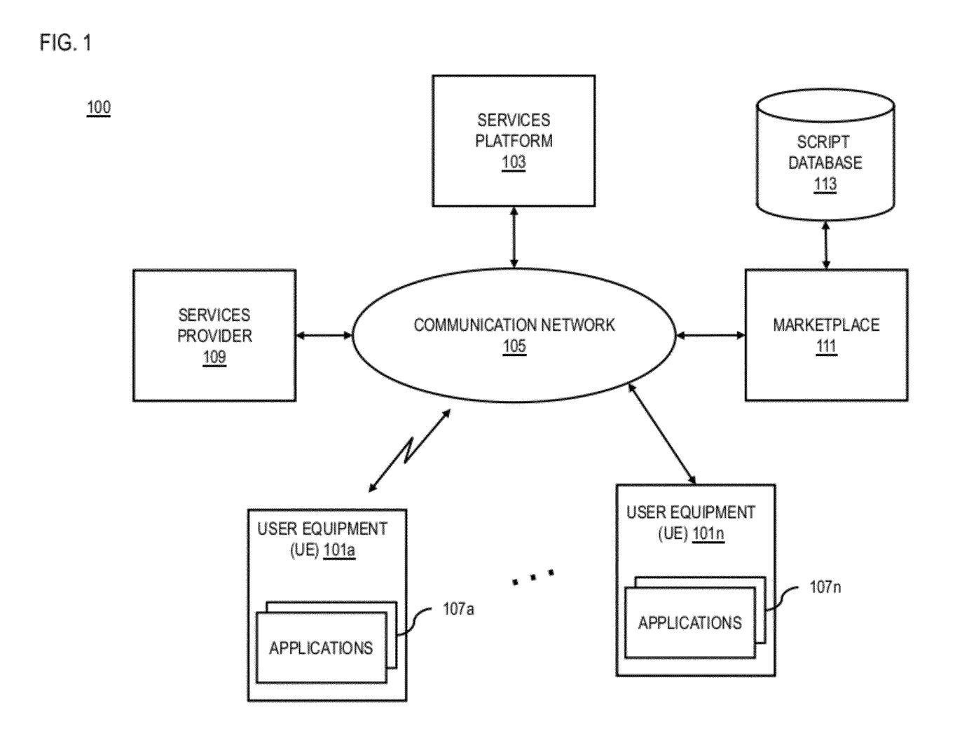

FIG. 1 is a diagram of a system capable of using scripts to utilize a service, according to one embodiment. As previously noted, integration of services into one or more devices can take substantial effort while only providing a mild benefit for service providers over customary services provided by the service providers. For example, a service provider may provide a web page to access, via a desktop computer, the service. The service may include an interface for the user to utilize based on the service.

To customize the service to one or more particular devices, the service provider may need to expend a great deal of resources (e.g., to learn and develop an application to utilize with the devices). Costs can rise if the service provider needs to generate separate applications for each device. The service provider may additionally need to create both a front end as well as a back end to implement the service on one or more of the devices. These would be on top of a user interface (e.g., a web interface) already created by the service provider. As such, a low effort alternative to creating service applications and/or service interfaces can be useful. Additionally, there is a lack of convenient approaches to access a service when a multitude of services are available.

To address this problem, a system 100 of FIG. 1 introduces the capability to use scripts to utilize a service. The scripts can be implemented to utilize already made service interfaces (e.g., a web-based user interface) to perform one or more tasks. Further, the scripts can be created by one or more developers, one or more users, etc. utilizing front end software that implements the scripts. These scripts can be utilized on user equipment (UEs) 101a-101n that connect to a services platform 103 via a communication network 105. One or more applications 107a-107n can utilize these scripts to present content to users. These applications 107 can include web browsers, UE native applications (e.g., a contact list, a messaging program, etc.), other UE applications (e.g., web runtime based applications), integrations between one or more applications 107, or the like. The scripts can be made by one or more services providers 109, users of UEs 101, or other users with interest. Examples of services include image sharing sites, navigation sites, mapping sites, micro blogging sites (e.g., including current location information and/or music listed to on the UE 101 information), purchasing and/or gift acquisition sites, etc.

In one example, the application 107 can include a browser application. The browser application can utilize a script engine browser plugin that can execute one or more scripts within the browser (e.g., in the background). Different types of script engine browser plugins can be generated for different types of browsers and/or for different devices.

In another example, support for a content handler can be implemented in the UE 101. Support for content handlers can be, according to certain embodiments, integrations in an operating system and/or application 107 of the UE 101 that allow for scripts to appear in a menu (e.g., a menu associated with a target object). As used herein, the term target object refers to an entity that can be manipulated by commands. Target objects can be represented by, for example, data structures. Further, target objects may include a user interface component or representation. In one embodiment, a target object can be a contact in a phone book, an image, or any other object viewed using a UE 101.

The UE 101 can additionally include one or more applications 107 and/or operating system support for installing and/or removing scripts. For example, a script installation application (e.g., an installation wizard) can be used to download scripts from, e.g., a script marketplace 111. In certain scenarios, a script marketplace 111 includes a script database 113 or store and can be utilized to search, access, and/or download scripts. As such, one or more applications 107 (e.g., a marketplace application, browser, etc.) can be utilized to install scripts (e.g., to use with a browser). For example, a script installation browser plugin may be utilized to integrate the script (e.g., to generate a package that can be utilized to integrate the script with the browser, operating system, or the like). Access to the marketplace 111 can be provided for service providers 109, users of UEs 101, and/or other users (e.g., third-party developers). The scripts can thus be generated by the service providers 109, users, or third-party developers.

The scripts can further utilize the already existing service interface (e.g., a web browser interface implemented via the services platform 103). That is, the services platform 103 can be utilized to provide access to one or more services (e.g., via a web based interface) to users of UEs 101. Further, services can be integrated using task-specific scripts that automate either fully or partially the performance of a task using a web browser.

In one example, for an image sharing website, an example task may be to upload a new image and its description to the website. The script can act upon a target object, such as the new image. Further, the script can use target object information (e.g., metadata associated with the image, an associated contact information associated with a contact target object, etc.) to perform the task. Utilizing target object information reduces the need for user data entry. With this approach, a new interface need not be created specifically for input of such information. Moreover, contextual information (e.g., a location, an orientation, time of day, etc.) associated with the user, UE 101, etc. can additionally be utilized in execution of the script. Contextual information can be retrieved from the UE 101. The UE 101, software on the UE 101, etc. may provide an interface to allow the script to access the target object information as well as the contextual information.

Further, the script can define user-entered parameters that can be utilized to fill information associated with the service interface. These parameters can be queried utilizing a customized user interface. Such a customized user interface can include, for example, a popup menu, context menu, etc. For example, one or more scroll based selection inputs, one or more character entry fields, or the like can be provided to the user. The interface can be more user friendly than a web based interface that the services platform 103 may provide. This can be because web based interfaces are generally customized for desktop computer use while UEs 101 need not all be desktop computers. For example, a mobile UE 101 may include limited screen space and/or character entry.

When a script is executed, a web browser can be utilized to load a service web page from the services platform 103. The script can additionally run in the background and react to browser events. Browser events can be customized in the script. For example, if a particular service interface (e.g., identified by a page name, page pointer, etc.) is utilized by the services platform 103, the script can detect an event and perform a particular task based on the event. As such, automation implemented by the script can coexist with user interaction.

By way of example, scripts can include actions for opening a link in a web browser, sending a Simple Object Access Protocol (SOAP) or REpresentational State Transfer (REST) request, sending a short message service (SMS), sending a multimedia messaging service (MMS), sending an e-mail, running a piece of JavaScript code, executing an application, or the like. The scripts can be set up with the requisite instructions to execute on a UE 101. Some scripts can be based on one or more templates specific to a certain type, brand, or model of UE 101. Further, scripts can be provided with little or no trust by corresponding interfaces. Limiting trustworthiness of scripts allows for a limited need to infrastructure to support trust. As such, the service provider 109 need not implement such features to utilize the scripts, decreasing the required time and investment in creating the script. Moreover, by scripting browser implementations rather than relying on Application Programming Interfaces (APIs) of services, automation can be made to any/all web-based services rather than just those that have programming interfaces.

In one embodiment, scripts can include target object properties, context properties, user-entered parameters, or a combination thereof. Target object properties can include information stored in a data structure associated with the target object. For example, a contact target object can include properties such as contact name, contact address, contact telephone number, etc. Contextual properties can be values that can be automatically determined but are not related to the target object. For example contextual properties can include current location, current time, last media (e.g., music, picture, video, etc.) played/viewed by the user, user name, age, address, etc. Target object properties and/or context properties can be utilized to populate associated fields using scripts. If a property is unknown, invalid, etc. the user can be asked to validate and/or populate the property information.

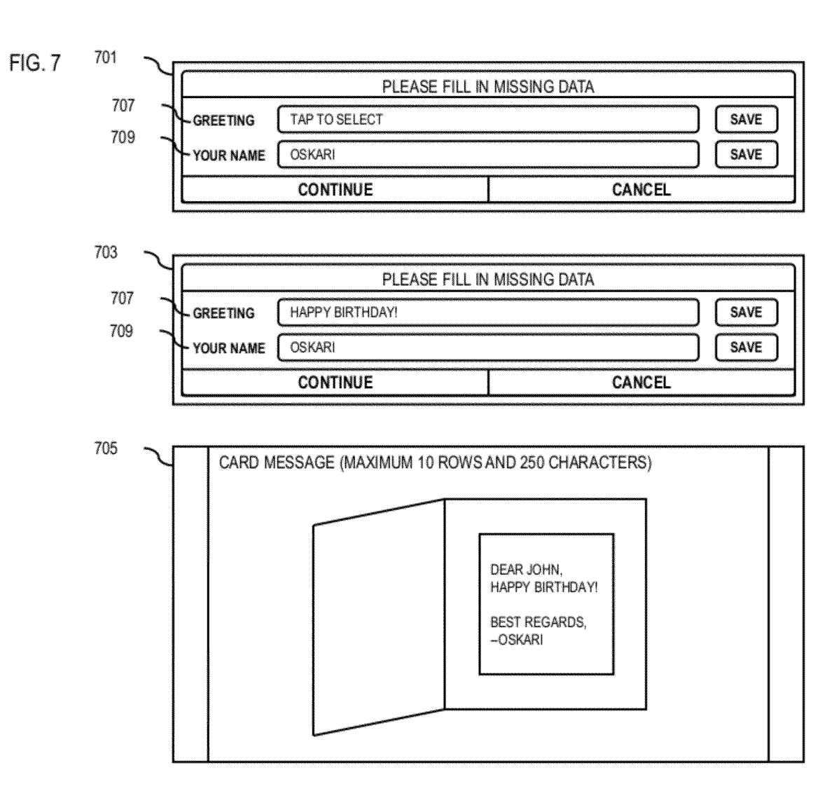

Further, scripts can utilize one or more parameters. In certain embodiments, parameters are values that cannot be automatically determined and should be entered by the user. Once such values are entered by the user, the values can be saved for future use. As such, the script(s) can reuse such information to automate information population (e.g., as a default value entered, as a predictive text entry, etc.). In certain embodiments, the parameters are unknown to the services system without the script. As such, the script can provide appropriate information to enable user data entry (e.g., input control type, one or more labels, possible values, helpful text, related texts entries to a particular field, etc.). For example, in a greeting card application situation as shown in FIG. 7, the script could define that an input control type is open-ended selection (e.g., a combination box), possible values can include “happy birthday,” “congratulations,” or other entries, the label for a particular field is “greeting,” helpful text can include “please select a greeting,” etc. Further, these fields can be connected to a language dictionary to allow for different views based on language settings and/or location contextual information.

Some services by the services provider 109 can include end user license agreements or acknowledgement of one or more disclaimers. To support these features of services, scripts can define one or more legal disclaimers and/or confirmation texts. Further, the scripts can utilize text information and/or object information associated with a web page (e.g., utilizing HyperText Markup Language (HTML) div elements) to present to the user. As with other legal disclaimers, the legal disclaimer can be persistent (e.g., checked each time the service is executed) or the response can be saved.

In certain embodiments, scripts are declarative. That is, the scripts are written by declaring what the script wants to accomplish, not how. As such, it is easier to limit the possible malicious actions that can be performed by the script. Further, the user can expressly provide permission for the script to access private data and/or secure data. In certain scenarios, scripts cannot access private and/or secure data without express permission. This can be useful to limit the possibility of credit card number theft because the script cannot access such numbers. Thus, in certain embodiments, the scripts can only access target object and/or contextual data the scripts have declared to need/use. Moreover, the scripts may have privacy enforcement by the browser and/or other application utilizing the scripts that only allows the scripts to make contact with one or more services associated with the scripts. In one example, private information accessible by the scripts may only be sent to the associated service(s). This may be accomplished by allowing for signing of the scripts with one or more services. Further, a list of needed/requested data can be shown to the user before the script is activated, thus allowing the user to deny access.

Additionally or alternatively, the scripts can be generated utilizing one or more graphical building tools. For example, a script can be created from a set of individually small and/or independent items that have well-understood semantics. A wizard style interface can be used that can ask for each item in turn. For many items (e.g., target object type, property selection, parameter selection, action selection, etc.), there is a known list of possible alternatives. For other items (e.g., conditions, parameter values, etc.) short scripting expressions may be needed to be entered. Further, in certain embodiments, a script generation wizard tool can read an HTML file to parse out possible semantic information associated with data entry fields.

As shown in FIG. 1, the system 100 comprises a UE 101 having connectivity to other UEs 101, services providers 109, services platforms 103, marketplaces, etc. via the communication network 105. By way of example, the communication network 105 of system 100 includes one or more networks such as a data network (not shown), a wireless network (not shown), a telephony network (not shown), or any combination thereof. It is contemplated that the data network may be any local area network (LAN), metropolitan area network (MAN), wide area network (WAN), a public data network (e.g., the Internet), short range wireless network, or any other suitable packet-switched network, such as a commercially owned, proprietary packet-switched network, e.g., a proprietary cable or fiber-optic network, and the like, or any combination thereof. In addition, the wireless network may be, for example, a cellular network and may employ various technologies including enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., worldwide interoperability for microwave access (WiMAX), Long Term Evolution (LTE) networks, code division multiple access (CDMA), wideband code division multiple access (WCDMA), wireless fidelity (WiFi), wireless LAN (WLAN), Bluetooth®, Internet Protocol (IP) data casting, satellite, mobile ad-hoc network (MANET), and the like, or any combination thereof.

The UE 101 is any type of mobile terminal, fixed terminal, or portable terminal including a mobile handset, station, unit, device, multimedia computer, multimedia tablet, Internet node, communicator, desktop computer, laptop computer, notebook computer, netbook computer, tablet computer, personal communication system (PCS) device, personal navigation device, personal digital assistants (PDAs), audio/video player, digital camera/camcorder, positioning device, television receiver, radio broadcast receiver, electronic book device, game device, or any combination thereof, including the accessories and peripherals of these devices, or any combination thereof. It is also contemplated that the UE 101 can support any type of interface to the user (such as “wearable” circuitry, etc.).

By way of example, the UEs 101, services provider 109, services platform 103, and marketplace 111 communicate with each other and other components of the communication network 105 using well known, new or still developing protocols. In this context, a protocol includes a set of rules defining how the network nodes within the communication network 105 interact with each other based on information sent over the communication links. The protocols are effective at different layers of operation within each node, from generating and receiving physical signals of various types, to selecting a link for transferring those signals, to the format of information indicated by those signals, to identifying which software application executing on a computer system sends or receives the information. The conceptually different layers of protocols for exchanging information over a network are described in the Open Systems Interconnection (OSI) Reference Model.

Communications between the network nodes are typically effected by exchanging discrete packets of data. Each packet typically comprises (1) header information associated with a particular protocol, and (2) payload information that follows the header information and contains information that may be processed independently of that particular protocol. In some protocols, the packet includes (3) trailer information following the payload and indicating the end of the payload information. The header includes information such as the source of the packet, its destination, the length of the payload, and other properties used by the protocol. Often, the data in the payload for the particular protocol includes a header and payload for a different protocol associated with a different, higher layer of the OSI Reference Model. The header for a particular protocol typically indicates a type for the next protocol contained in its payload. The higher layer protocol is said to be encapsulated in the lower layer protocol. The headers included in a packet traversing multiple heterogeneous networks, such as the Internet, typically include a physical (layer 1) header, a data-link (layer 2) header, an internetwork (layer 3) header and a transport (layer 4) header, and various application headers (layer 5, layer 6 and layer 7) as defined by the OSI Reference Model.

In one embodiment, the services platform 103, services provider 109, and/or marketplace 111 may interact according to a client-server model with the applications 109 of the UE 101. According to the client-server model, a client process sends a message including a request to a server process, and the server process responds by providing a service (e.g., navigation, ordering, etc.). The server process may also return a message with a response to the client process. Often the client process and server process execute on different computer devices, called hosts, and communicate via a network using one or more protocols for network communications. The term “server” is conventionally used to refer to the process that provides the service, or the host computer on which the process operates. Similarly, the term “client” is conventionally used to refer to the process that makes the request, or the host computer on which the process operates. As used herein, the terms “client” and “server” refer to the processes, rather than the host computers, unless otherwise clear from the context. In addition, the process performed by a server can be broken up to run as multiple processes on multiple hosts (sometimes called tiers) for reasons that include reliability, scalability, and redundancy, among others.

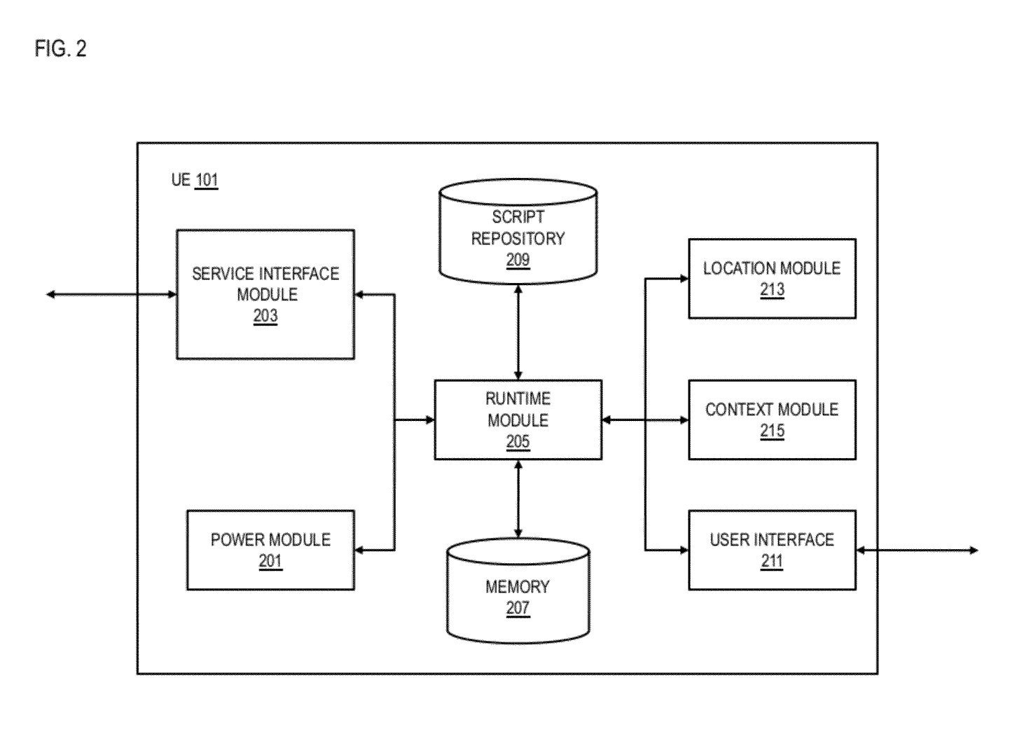

FIG. 2 is a diagram of the components of a UE 101, according to one embodiment. By way of example, the UE 101 includes one or more components for running scripts for service integration. It is contemplated that the functions of these components may be combined in one or more components or performed by other components of equivalent functionality. In this embodiment, the UE 101 includes a power module 201, a service interface module 203, a runtime module 205, memory 207, a script repository 209, a user interface 211, a location module 213, and a context module 215.

The power module 201 provides power to a UE 101. The power module 201 can include any type of power source (e.g., battery, plug-in, etc.). Additionally, the power module 201 can provide power to the components of the UE 101 including processors, memory, and transmitters.

The service interface module 203 can be used by the runtime module 205 to communicate with a services platform 103 or a services provider 109. In some embodiments, the service interface module 203 is used to download scripts via one or more plugin libraries to store in the script repository 209. These scripts can be retrieved from, for example, a marketplace 111. Additionally, the service interface module 203 can be used by the runtime module 205 to browse content of the services provider 109. Further, the runtime module 205 can execute script plugins to communicate with a services provider 109 and/or services platform 103 via the service interface module 203.

The script repository 209 can include plugins, including one or more scripts. Further, the UE 101 manufacturer may install scripts and/or plugins in the UE 101 at manufacture time. One plugin in the plugin library can be used to open a web page, another plugin can be used to send information via a MMS, and yet another plugin can be used to send information via SOAP or REST. In one embodiment the SOAP or REST services plugin can be a submission and reply handling plugin. When the runtime module 205 executes a script, the script can use a configuration provided by a service provider, as well as data content about a current target object (e.g., a contact item) and/or current context as parameters. The configuration can be a file separate from the script from which the script draws or can be combined with the script when generating the plugin.

In one embodiment, the script/plugin can be signed by the maker of the UE 101 or particular software associated with the UE 101. In this embodiment, the plugin can fully utilize particular target object of the UE 101 (e.g., has access to certain sensitive information, for example, the location of the user).

In another embodiment, a UE 101 includes a user interface 211. The user interface 211 can include various methods of communication. For example, the user interface 211 can have outputs including a visual component (e.g., a screen), an audio component, a physical component (e.g., vibrations), and other methods of communication. User inputs can include a touch-screen interface, a scroll-and-click interface, a button interface, etc.

A user can input a request to upload or receive object information via the user interface 211. In one embodiment, the user interface 211 can include a list view, where the user can be viewing many items, but is focused on a specific target object (e.g., by activating a context menu of the item).

In another embodiment, the user interface 211 can include a detail view, where a target object is associated with the entire view. In a contacts detail view, the most commonly used actions can be emphasized. For example, the detail view can have both a service menu action offering access to applicable action plugins by category, and/or direct access links for the most popular plugin scripts. An example of a detail view is when a user is viewing an image taking up the screen or when a user is viewing a single contact. In another embodiment, the user interface 211 can have a home-screen. An action that need not require a target object (e.g., ordering a taxi to the user's location) can be accessed from a home-screen that can present or display multiple plugins.

In one embodiment, a UE 101 includes a location module 213. This location module 213 can determine a user's location. The user's location can be determined by a triangulation system such as Global Positioning System (GPS), Assisted GPS (A-GPS), Cell of Origin, or other location extrapolation technologies. Standard GPS and A-GPS systems can use satellites to pinpoint the location of a UE 101. A Cell of Origin system can be used to determine the cellular tower that a cellular UE 101 is synchronized with. This information provides a coarse location of the UE 101 because the cellular tower can have a unique cellular identifier (cell-ID) that can be geographically mapped. The location module 213 may also utilize multiple technologies to detect the location of the UE 101. GPS coordinates can provide finer detail as to the location of the UE 101 when media is captured. The runtime module 205 can also extrapolate addresses from the information gathered from the location module 213.

In one embodiment, a UE 101 has a context module 215. The context module 215 can obtain contextual information about a user of the UE 101. In one example, the context module 215 can retrieve location data of the user from the location module 213. In another example, the context module 215 can retrieve temporal data (e.g., a contact's birthday or a calendar entry) about a target object. In a further example, the context module 215 can obtain other context data or content data about the target object.

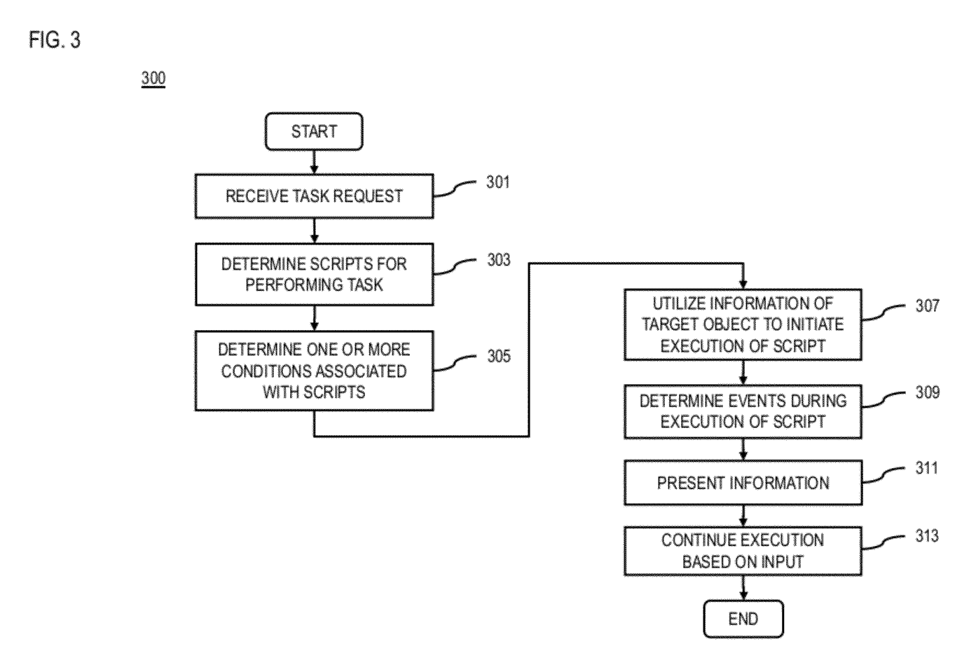

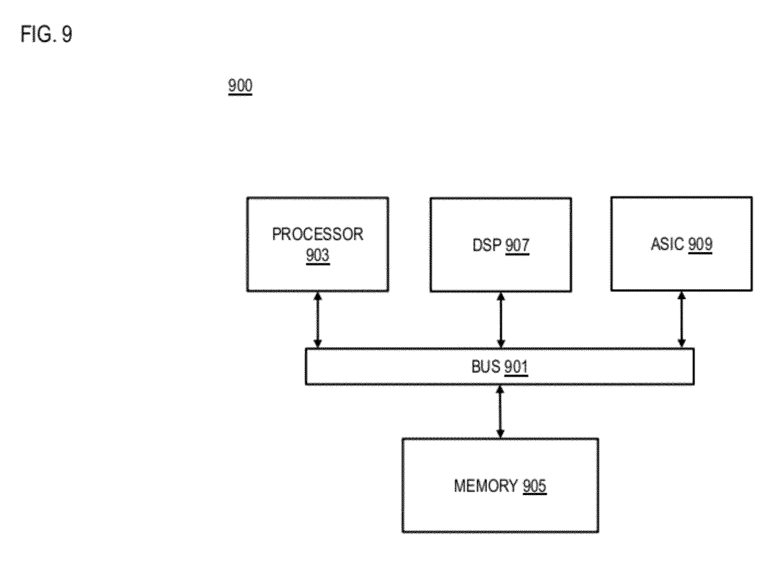

FIG. 3 is a flowchart of a process for using scripts to utilize a service, according to one embodiment. In one embodiment, an application 107 (e.g., executing on a runtime module 205) performs the process 300 and is implemented in, for instance, a chip set including a processor and a memory as shown in FIG. 9. Additionally or alternatively, one or more portions of the process 300 can be implemented via another device (e.g., the services platform 103), one or more other software modules, a combination thereof, etc. As such, the application 107 and/or other devices can be utilized as means for implementing one or more steps of the process 300.

At step 301, the application 107 receives a request specifying one or more tasks of a service with respect to a target object. The target object, as previously noted can be a data structure including information. A representation of the target object may be utilized in receiving the request. For example, if the target object is a contact of the user, the contact can be presented on a contact list. Selection of the contact (e.g., a long press on the contact) can activate a menu to utilize one or more scripts that can perform a task associated with a service. The menu may additionally enable the user to select a particular script to perform. In other scenarios, a browser application 107 can be executing, where one or more scripts may be requested based on an event occurrence (e.g., browsing to a particular web page). As previously noted, the one or more tasks can relate to populating information in one or more fields of a web page associated with the service, navigating the web page or a website associated with the service, combinations thereof, etc.

Then at step 303, the application 107 determines one or more scripts for performing the one or more tasks. As previously noted, the request may specify the scripts. Additionally or alternatively, the scripts can be determined based on an event. In certain embodiments, an event is an action that can be handled by code. The event can be based on user input (e.g., the request), a state of the application 107 or other applications (e.g., a determination that a particular website address is being presented), or the like.

One or more conditions associated with the scripts can be determined (step 305). The condition(s) can relate to one or more event properties, a web page associated with the service, one or more script parameters, combinations thereof, etc. In certain embodiments, script parameters can include any information available to the script(s) that may be utilized to perform tasks. In one example, script conditions can be simple comparisons, regular expressions (e.g., JavaScript expressions), etc. Conditions can be compared to a data structure (e.g., a table) to determine how a script operates. Conditions can be mapped to particular scripts to call based on an analysis of conditions (e.g., a first combination of conditions can be mapped to a first script, another combination can be mapped to a second script, etc.). For example, a first condition could include the selection of a contact and a second condition can be an analysis of contact information associated with the contact to determine that the contact information includes an address or other location information. Moreover, conditions can relate to event properties (e.g., one or more page elements activated by a user), a current web address (e.g., Uniform Resource Locator, content information, etc.), one or more script parameters (e.g., a target object, context, user-entered parameters, etc.), etc.

At step 307, the application 107 can determine to initiate the one or more scripts to use, at least in part, information associated with the target object to perform the one or more tasks. The conditions can additionally be utilized to initiate the scripts. In certain scenarios, options to select one or more scripts can be presented to the user based on conditions. For example, a script can have an associated condition that it is applicable to one or more particular target objects (e.g., a contact target object that has associated with it a home address). Further, a condition can include, for example, a long press on the target object. Additionally or alternatively, such conditions can be utilized to filter script use based on time. For example, time information associated with when a service associated with the script can be utilized can be used to generate conditions for when to present the script as an option. As such, if a service operates only during the office hours, the condition can be based on the office hours. Current time context information can be determined from the UE 101.

Moreover, one or more portions of target object information (e.g., information associated with the target object) may be used in the execution of the script. For example, an address of the contact may be utilized by the script to populate a delivery field of an interface (e.g., a web browser interface) to the service. The scripts may additionally execute concurrently with an application (e.g., a browser) presenting a web page or website.

Additionally or alternatively, the conditions can relate to one or more privacy policies, one or more security policies, combinations thereof, etc. Privacy policy conditions and/or security policy conditions can be associated with a determination of whether or not to enable access for the script to one or more target objects and/or particular information associated with the target objects.

In certain embodiments, for security reasons, the execution of scripts is limited to one or more predefined actions. These actions can be deemed safe and may have simple action parameters. For example, such actions can include: filling a form field with target object information, submit a form, load a new web page, emulate a mouse click or key press, dispatch an event, show a message to the user, etc.

Further, during the execution of the script, one or more events can be determined (step 309). As previously noted, the events can include detection by the script that a browser has navigated to a particular web page. An event may be based on one or more combinations of one or more conditions. The event can trigger execution of one or more portions of a script.

In one scenario, the event triggers the UE 101 to determine to present information associated with the event (step 311). In one example, the event can trigger presentation of a cue that indicates the execution of the script(s). The cue can be presented on an edge of a screen. In this manner, the user receives knowledge that the script is executing. Moreover, the script(s) can initiate presentation of a prompt for information.

The information can include, for example, a prompt to the user to provide access of private data, secure data, or combinations thereof to the script. This prompt can be based on a determination that the target object has secure information (e.g., based on a determination that the target object or particular information associated with the target object is secure or password protected). As such, an interface can be provided to the user to allow the script to access the information and/or to provide an access code or password to enable access to the information.

The presentation can additionally or alternatively include presentation of a prompt for other information (e.g., for the user to input information into a field, input a selection of particular parameters, input for access information, etc.). The prompt can be customized for the device and be utilized as an intermediary interface between the user and a service interface (e.g., the browser interface). The UE 101 can receive input from the user based on the prompt and the application 107 can then continue execution of the script(s) and/or service based on the input (step 313).

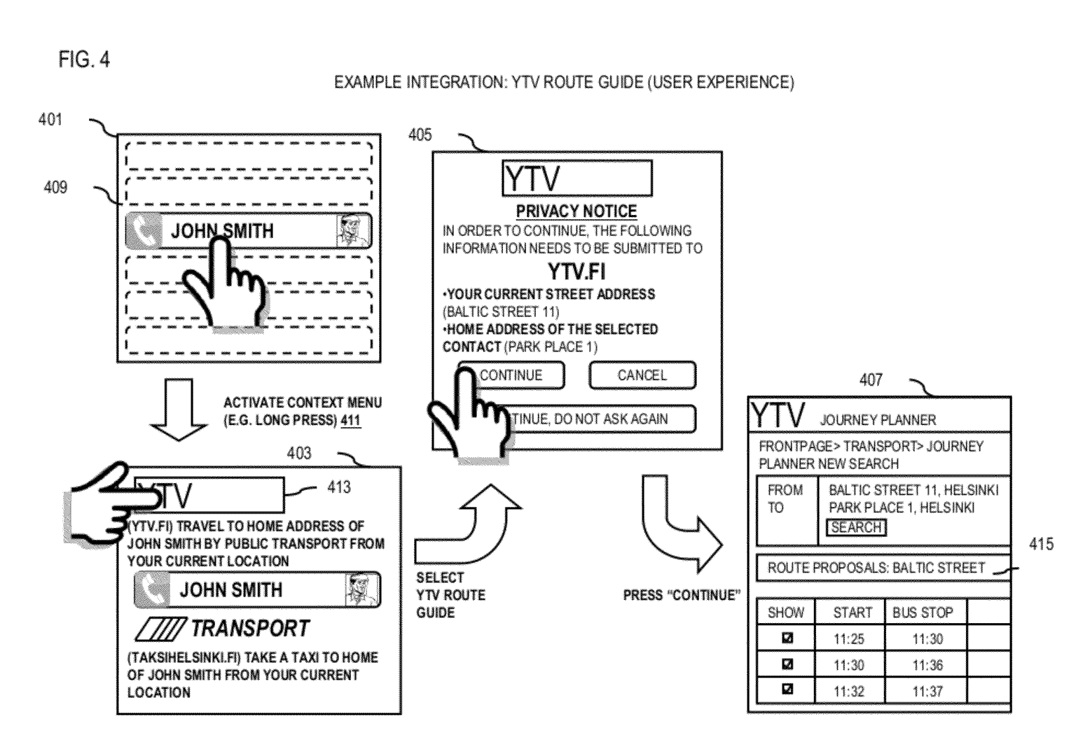

FIGS. 4-7 are diagrams of user interfaces utilized in the processes of FIG. 3, according to various embodiments. FIG. 4 shows user interfaces 401, 403, 405, 407 that are associated with a navigation application that can be utilize scripts to access a web interface. User interface 401 shows a contact list 409 including a contact, John Smith. The user can utilize, for example, a touch screen interface to activate 411 the service (e.g., by utilizing a long press on the touch screen). Information associated with the service can then be presented to the user via a user interface 403. This information can be presented based on a script executed based on the long press request. The user can select an option 413 from the service to provide a service (e.g., directions, requesting a taxi based on context information (e.g., a GPS location), etc.).

Then, at user interface 405, a prompt can be presented based on the selection event option 413 selected by the user. The user interface 405 can show, for example, a script based prompt to the user. The prompt shows a privacy warning to notify the user that target object information (e.g., the address of a contact, John Smith) and/or context information (e.g., the current address that the UE 101 is located) is being sent to the service. In response to an input to continue, user interface 407 shows route options 415 to utilize public transportation to the user.

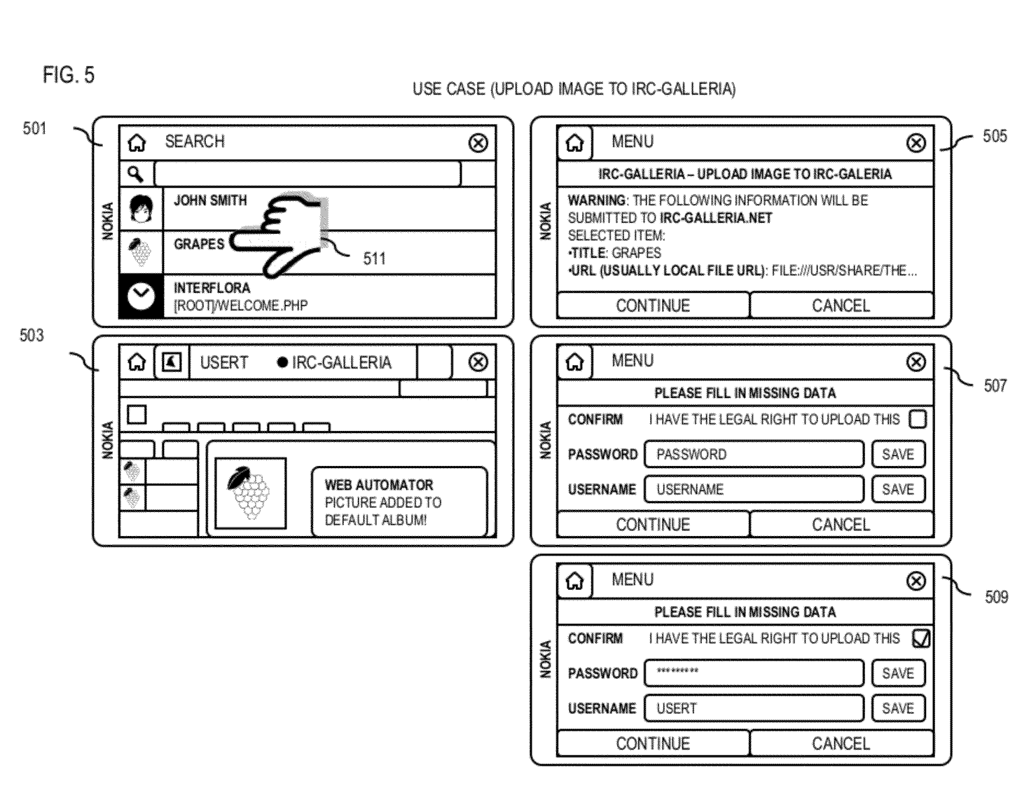

FIG. 5 shows user interfaces 501, 503, 505, 507, 509 associated with a service to upload an image, according to various embodiments. A user interface 501 can present search information according to an application of the UE 101. For example, the search can be for media associated with the UE 101. The user can select 511 the image (e.g., grapes). The selection can be utilized as a request and/or event to automatically add the picture to an album associated with the service. The target object (image) can then be parsed for metadata to utilize as a title (grapes) associated with the image as shown in user interface 505. In this manner, information can be populated based on the target object and one or more scripts. As noted above, the scripts may be utilized to use a browser interface to pass the information. Further, as shown in user interface 507, the user can be prompted to provide authentication information to upload the image. The prompt can be customized to efficiently present information/receive input based on one or more scripts. The user can provide authentication information as shown in user interface 509, allowing the service to further execute.

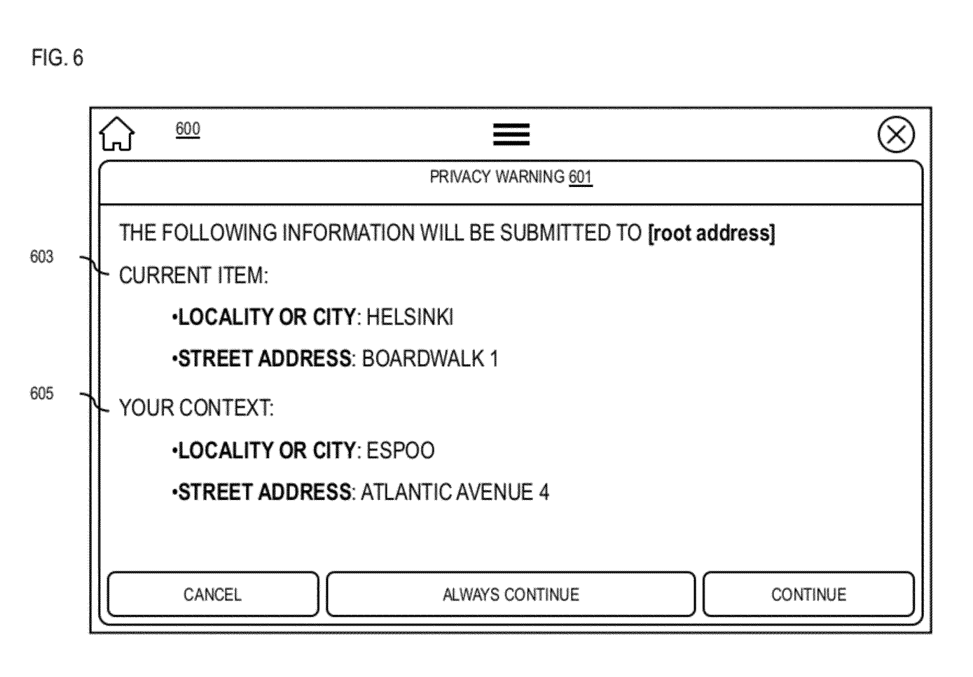

FIG. 6 shows a user interface 600 showing a privacy warning 601. The privacy warning 601 presents information to the user that a service utilized by the user is being sent information associated with a target object or current item 603 of the UE 101 and/or context information 605 associated with the UE 101. The user can select a default or current option to allow such information to be passed to the service. As such, future scripts can be utilized without warning (e.g., based on cookie information associated with a browser executing one or more scripts).

FIG. 7 shows user interfaces 701, 703, 705 that utilize user entered parameters to provide information to a service. For example, these parameters cannot be automatically determined and should be entered by a user. For example, a customized greeting 707 may need to be entered based on user input. Some associated parameters, for example, the user's name 709, can be determined from a target object on the UE 101. As such, some input parameters can be input by the user, while other fields can be automatically determined by scripts. The user may additionally have options to change one or more fields. In certain scenarios, the greeting field 707 can be tapped to select one or more predefined options (e.g., Happy Birthday, congratulations, etc.). Predefined options allow for the user to quickly and conveniently provide data entry. Thus, an optimized user experience can be provided.

The processes described herein for using scripts to utilize a service may be advantageously implemented via software, hardware, firmware or a combination of software and/or firmware and/or hardware. For example, the processes described herein, may be advantageously implemented via processor(s), Digital Signal Processing (DSP) chip, an Application Specific Integrated Circuit (ASIC), Field Programmable Gate Arrays (FPGAs), etc. Such exemplary hardware for performing the described functions is detailed below.

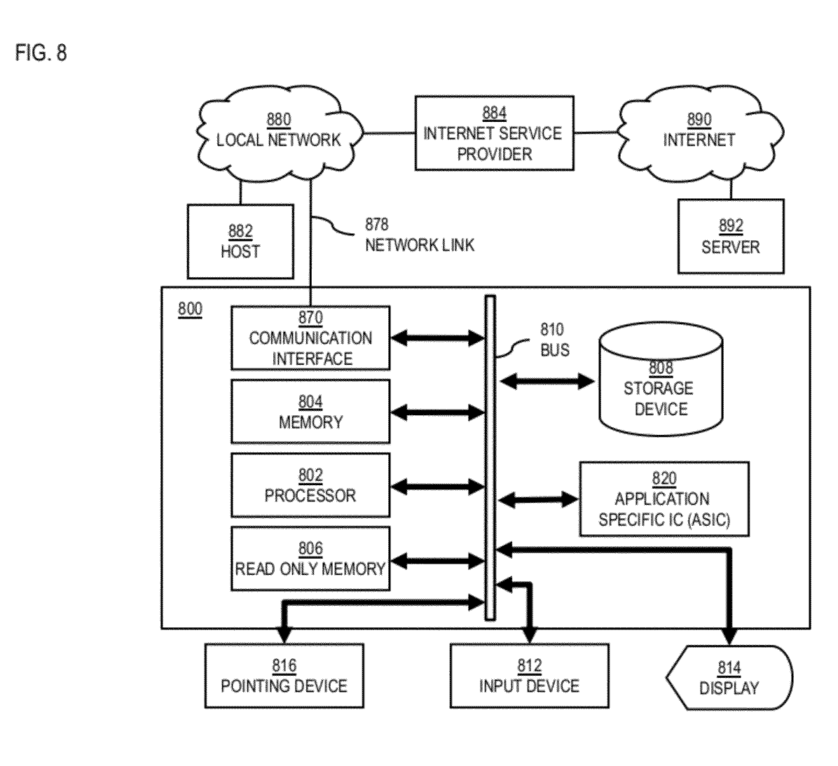

FIG. 8 illustrates a computer system 800 upon which an embodiment of the invention may be implemented. Although computer system 800 is depicted with respect to a particular device or equipment, it is contemplated that other devices or equipment (e.g., network elements, servers, etc.) within FIG. 8 can deploy the illustrated hardware and components of system 800. Computer system 800 is programmed (e.g., via computer program code or instructions) to use scripts to utilize a service as described herein and includes a communication mechanism such as a bus 810 for passing information between other internal and external components of the computer system 800. Information (also called data) is represented as a physical expression of a measurable phenomenon, typically electric voltages, but including, in other embodiments, such phenomena as magnetic, electromagnetic, pressure, chemical, biological, molecular, atomic, sub-atomic and quantum interactions. For example, north and south magnetic fields, or a zero and non-zero electric voltage, represent two states (0, 1) of a binary digit (bit). Other phenomena can represent digits of a higher base. A superposition of multiple simultaneous quantum states before measurement represents a quantum bit (qubit). A sequence of one or more digits constitutes digital data that is used to represent a number or code for a character. In some embodiments, information called analog data is represented by a near continuum of measurable values within a particular range. Computer system 800, or a portion thereof, constitutes a means for performing one or more steps of using scripts to utilize a service.

A bus 810 includes one or more parallel conductors of information so that information is transferred quickly among devices coupled to the bus 810. One or more processors 802 for processing information are coupled with the bus 810.

A processor (or multiple processors) 802 performs a set of operations on information as specified by computer program code related to use scripts to utilize a service. The computer program code is a set of instructions or statements providing instructions for the operation of the processor and/or the computer system to perform specified functions. The code, for example, may be written in a computer programming language that is compiled into a native instruction set of the processor. The code may also be written directly using the native instruction set (e.g., machine language). The set of operations include bringing information in from the bus 810 and placing information on the bus 810. The set of operations also typically include comparing two or more units of information, shifting positions of units of information, and combining two or more units of information, such as by addition or multiplication or logical operations like OR, exclusive OR (XOR), and AND. Each operation of the set of operations that can be performed by the processor is represented to the processor by information called instructions, such as an operation code of one or more digits. A sequence of operations to be executed by the processor 802, such as a sequence of operation codes, constitute processor instructions, also called computer system instructions or, simply, computer instructions. Processors may be implemented as mechanical, electrical, magnetic, optical, chemical or quantum components, among others, alone or in combination.

Computer system 800 also includes a memory 804 coupled to bus 810. The memory 804, such as a random access memory (RAM) or any other dynamic storage device, stores information including processor instructions for using scripts to utilize a service. Dynamic memory allows information stored therein to be changed by the computer system 800. RAM allows a unit of information stored at a location called a memory address to be stored and retrieved independently of information at neighboring addresses. The memory 804 is also used by the processor 802 to store temporary values during execution of processor instructions. The computer system 800 also includes a read only memory (ROM) 806 or any other static storage device coupled to the bus 810 for storing static information, including instructions, that is not changed by the computer system 800. Some memory is composed of volatile storage that loses the information stored thereon when power is lost. Also coupled to bus 810 is a non-volatile (persistent) storage device 808, such as a magnetic disk, optical disk or flash card, for storing information, including instructions, that persists even when the computer system 800 is turned off or otherwise loses power.

Information, including instructions for using scripts to utilize a service, is provided to the bus 810 for use by the processor from an external input device 812, such as a keyboard containing alphanumeric keys operated by a human user, or a sensor. A sensor detects conditions in its vicinity and transforms those detections into physical expression compatible with the measurable phenomenon used to represent information in computer system 800. Other external devices coupled to bus 810, used primarily for interacting with humans, include a display device 814, such as a cathode ray tube (CRT), a liquid crystal display (LCD), a light emitting diode (LED) display, an organic LED (OLED) display, a plasma screen, or a printer for presenting text or images, and a pointing device 816, such as a mouse, a trackball, cursor direction keys, or a motion sensor, for controlling a position of a small cursor image presented on the display 814 and issuing commands associated with graphical elements presented on the display 814. In some embodiments, for example, in embodiments in which the computer system 800 performs all functions automatically without human input, one or more of external input device 812, display device 814 and pointing device 816 is omitted.

In the illustrated embodiment, special purpose hardware, such as an application specific integrated circuit (ASIC) 820, is coupled to bus 810. The special purpose hardware is configured to perform operations not performed by processor 802 quickly enough for special purposes. Examples of ASICs include graphics accelerator cards for generating images for display 814, cryptographic boards for encrypting and decrypting messages sent over a network, speech recognition, and interfaces to special external devices, such as robotic arms and medical scanning equipment that repeatedly perform some complex sequence of operations that are more efficiently implemented in hardware.

Computer system 800 also includes one or more instances of a communications interface 870 coupled to bus 810. Communication interface 870 provides a one-way or two-way communication coupling to a variety of external devices that operate with their own processors, such as printers, scanners and external disks. In general the coupling is with a network link 878 that is connected to a local network 880 to which a variety of external devices with their own processors are connected. For example, communication interface 870 may be a parallel port or a serial port or a universal serial bus (USB) port on a personal computer. In some embodiments, communications interface 870 is an integrated services digital network (ISDN) card or a digital subscriber line (DSL) card or a telephone modem that provides an information communication connection to a corresponding type of telephone line. In some embodiments, a communication interface 870 is a cable modem that converts signals on bus 810 into signals for a communication connection over a coaxial cable or into optical signals for a communication connection over a fiber optic cable. As another example, communications interface 870 may be a local area network (LAN) card to provide a data communication connection to a compatible LAN, such as Ethernet. Wireless links may also be implemented. For wireless links, the communications interface 870 sends or receives or both sends and receives electrical, acoustic or electromagnetic signals, including infrared and optical signals, that carry information streams, such as digital data. For example, in wireless handheld devices, such as mobile telephones like cell phones, the communications interface 870 includes a radio band electromagnetic transmitter and receiver called a radio transceiver. In certain embodiments, the communications interface 870 enables connection to the communication network 105 to the UE 101.

The term “computer-readable medium” as used herein refers to any medium that participates in providing information to processor 802, including instructions for execution. Such a medium may take many forms, including, but not limited to computer-readable storage medium (e.g., non-volatile media, volatile media), and transmission media. Non-transitory media, such as non-volatile media, include, for example, optical or magnetic disks, such as storage device 808. Volatile media include, for example, dynamic memory 804. Transmission media include, for example, twisted pair cables, coaxial cables, copper wire, fiber optic cables, and carrier waves that travel through space without wires or cables, such as acoustic waves and electromagnetic waves, including radio, optical and infrared waves. Signals include man-made transient variations in amplitude, frequency, phase, polarization or other physical properties transmitted through the transmission media. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, an EPROM, a FLASH-EPROM, an EEPROM, a flash memory, any other memory chip or cartridge, a carrier wave, or any other medium from which a computer can read. The term computer-readable storage medium is used herein to refer to any computer-readable medium except transmission media.

Logic encoded in one or more tangible media includes one or both of processor instructions on a computer-readable storage media and special purpose hardware, such as ASIC 820.

Network link 878 typically provides information communication using transmission media through one or more networks to other devices that use or process the information. For example, network link 878 may provide a connection through local network 880 to a host computer 882 or to equipment 884 operated by an Internet Service Provider (ISP). ISP equipment 884 in turn provides data communication services through the public, world-wide packet-switching communication network of networks now commonly referred to as the Internet 890.

A computer called a server host 892 connected to the Internet hosts a process that provides a service in response to information received over the Internet. For example, server host 892 hosts a process that provides information representing video data for presentation at display 814. It is contemplated that the components of system 800 can be deployed in various configurations within other computer systems, e.g., host 882 and server 892.

At least some embodiments of the invention are related to the use of computer system 800 for implementing some or all of the techniques described herein. According to one embodiment of the invention, those techniques are performed by computer system 800 in response to processor 802 executing one or more sequences of one or more processor instructions contained in memory 804. Such instructions, also called computer instructions, software and program code, may be read into memory 804 from another computer-readable medium such as storage device 808 or network link 878. Execution of the sequences of instructions contained in memory 804 causes processor 802 to perform one or more of the method steps described herein. In alternative embodiments, hardware, such as ASIC 820, may be used in place of or in combination with software to implement the invention. Thus, embodiments of the invention are not limited to any specific combination of hardware and software, unless otherwise explicitly stated herein.

The signals transmitted over network link 878 and other networks through communications interface 870, carry information to and from computer system 800. Computer system 800 can send and receive information, including program code, through the networks 880, 890 among others, through network link 878 and communications interface 870. In an example using the Internet 890, a server host 892 transmits program code for a particular application, requested by a message sent from computer 800, through Internet 890, ISP equipment 884, local network 880 and communications interface 870. The received code may be executed by processor 802 as it is received, or may be stored in memory 804 or in storage device 808 or any other non-volatile storage for later execution, or both. In this manner, computer system 800 may obtain application program code in the form of signals on a carrier wave.

Various forms of computer readable media may be involved in carrying one or more sequence of instructions or data or both to processor 802 for execution. For example, instructions and data may initially be carried on a magnetic disk of a remote computer such as host 882. The remote computer loads the instructions and data into its dynamic memory and sends the instructions and data over a telephone line using a modem. A modem local to the computer system 800 receives the instructions and data on a telephone line and uses an infra-red transmitter to convert the instructions and data to a signal on an infra-red carrier wave serving as the network link 878. An infrared detector serving as communications interface 870 receives the instructions and data carried in the infrared signal and places information representing the instructions and data onto bus 810. Bus 810 carries the information to memory 804 from which processor 802 retrieves and executes the instructions using some of the data sent with the instructions. The instructions and data received in memory 804 may optionally be stored on storage device 808, either before or after execution by the processor 802.

FIG. 9 illustrates a chip set or chip 900 upon which an embodiment of the invention may be implemented. Chip set 900 is programmed to use scripts to utilize a service as described herein and includes, for instance, the processor and memory components described with respect to FIG. 8 incorporated in one or more physical packages (e.g., chips). By way of example, a physical package includes an arrangement of one or more materials, components, and/or wires on a structural assembly (e.g., a baseboard) to provide one or more characteristics such as physical strength, conservation of size, and/or limitation of electrical interaction. It is contemplated that in certain embodiments the chip set 900 can be implemented in a single chip. It is further contemplated that in certain embodiments the chip set or chip 900 can be implemented as a single “system on a chip.” It is further contemplated that in certain embodiments a separate ASIC would not be used, for example, and that all relevant functions as disclosed herein would be performed by a processor or processors. Chip set or chip 900, or a portion thereof, constitutes a means for performing one or more steps of providing user interface navigation information associated with the availability of functions. Chip set or chip 900, or a portion thereof, constitutes a means for performing one or more steps of using scripts to utilize a service.

In one embodiment, the chip set or chip 900 includes a communication mechanism such as a bus 901 for passing information among the components of the chip set 900. A processor 903 has connectivity to the bus 901 to execute instructions and process information stored in, for example, a memory 905. The processor 903 may include one or more processing cores with each core configured to perform independently. A multi-core processor enables multiprocessing within a single physical package. Examples of a multi-core processor include two, four, eight, or greater numbers of processing cores. Alternatively or in addition, the processor 903 may include one or more microprocessors configured in tandem via the bus 901 to enable independent execution of instructions, pipelining, and multithreading. The processor 903 may also be accompanied with one or more specialized components to perform certain processing functions and tasks such as one or more digital signal processors (DSP) 907, or one or more application-specific integrated circuits (ASIC) 909. A DSP 907 typically is configured to process real-world signals (e.g., sound) in real time independently of the processor 903. Similarly, an ASIC 909 can be configured to performed specialized functions not easily performed by a more general purpose processor. Other specialized components to aid in performing the inventive functions described herein may include one or more field programmable gate arrays (FPGA) (not shown), one or more controllers (not shown), or one or more other special-purpose computer chips.

In one embodiment, the chip set or chip 900 includes merely one or more processors and some software and/or firmware supporting and/or relating to and/or for the one or more processors.

The processor 903 and accompanying components have connectivity to the memory 905 via the bus 901. The memory 905 includes both dynamic memory (e.g., RAM, magnetic disk, writable optical disk, etc.) and static memory (e.g., ROM, CD-ROM, etc.) for storing executable instructions that when executed perform the inventive steps described herein to use scripts to utilize a service. The memory 905 also stores the data associated with or generated by the execution of the inventive steps.

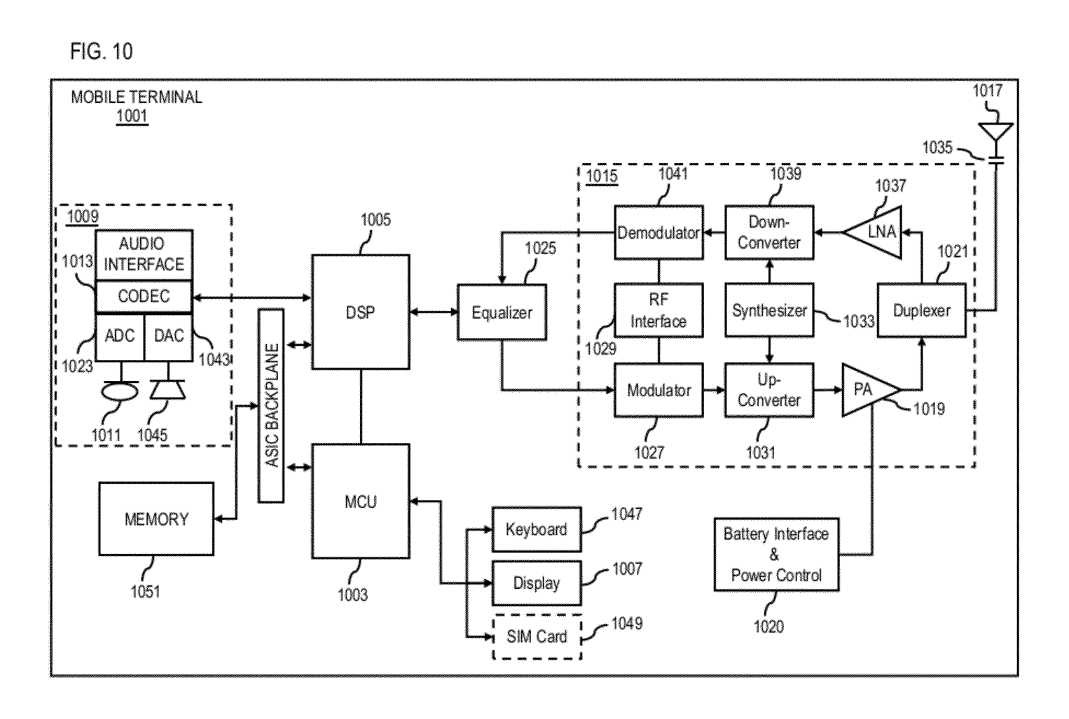

FIG. 10 is a diagram of exemplary components of a mobile terminal (e.g., handset) for communications, which is capable of operating in the system of FIG. 1, according to one embodiment. In some embodiments, mobile terminal 1001, or a portion thereof, constitutes a means for performing one or more steps of using scripts to utilize a service. Generally, a radio receiver is often defined in terms of front-end and back-end characteristics. The front-end of the receiver encompasses all of the Radio Frequency (RF) circuitry whereas the back-end encompasses all of the base-band processing circuitry. As used in this application, the term “circuitry” refers to both: (1) hardware-only implementations (such as implementations in only analog and/or digital circuitry), and (2) to combinations of circuitry and software (and/or firmware) (such as, if applicable to the particular context, to a combination of processor(s), including digital signal processor(s), software, and memory(ies) that work together to cause an apparatus, such as a mobile phone or server, to perform various functions). This definition of “circuitry” applies to all uses of this term in this application, including in any claims. As a further example, as used in this application and if applicable to the particular context, the term “circuitry” would also cover an implementation of merely a processor (or multiple processors) and its (or their) accompanying software/or firmware. The term “circuitry” would also cover if applicable to the particular context, for example, a baseband integrated circuit or applications processor integrated circuit in a mobile phone or a similar integrated circuit in a cellular network device or other network devices.

Pertinent internal components of the telephone include a Main Control Unit (MCU) 1003, a Digital Signal Processor (DSP) 1005, and a receiver/transmitter unit including a microphone gain control unit and a speaker gain control unit. A main display unit 1007 provides a display to the user in support of various applications and mobile terminal functions that perform or support the steps of using scripts to utilize a service. The display 1007 includes display circuitry configured to display at least a portion of a user interface of the mobile terminal (e.g., mobile telephone). Additionally, the display 1007 and display circuitry are configured to facilitate user control of at least some functions of the mobile terminal. An audio function circuitry 1009 includes a microphone 1011 and microphone amplifier that amplifies the speech signal output from the microphone 1011. The amplified speech signal output from the microphone 1011 is fed to a coder/decoder (CODEC) 1013.

A radio section 1015 amplifies power and converts frequency in order to communicate with a base station, which is included in a mobile communication system, via antenna 1017. The power amplifier (PA) 1019 and the transmitter/modulation circuitry are operationally responsive to the MCU 1003, with an output from the PA 1019 coupled to the duplexer 1021 or circulator or antenna switch, as known in the art. The PA 1019 also couples to a battery interface and power control unit 1020.

In use, a user of mobile terminal 1001 speaks into the microphone 1011 and his or her voice along with any detected background noise is converted into an analog voltage. The analog voltage is then converted into a digital signal through the Analog to Digital Converter (ADC) 1023. The control unit 1003 routes the digital signal into the DSP 1005 for processing therein, such as speech encoding, channel encoding, encrypting, and interleaving. In one embodiment, the processed voice signals are encoded, by units not separately shown, using a cellular transmission protocol such as enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), Long Term Evolution (LTE) networks, code division multiple access (CDMA), wideband code division multiple access (WCDMA), wireless fidelity (WiFi), satellite, and the like, or any combination thereof.

The encoded signals are then routed to an equalizer 1025 for compensation of any frequency-dependent impairments that occur during transmission though the air such as phase and amplitude distortion. After equalizing the bit stream, the modulator 1027 combines the signal with a RF signal generated in the RF interface 1029. The modulator 1027 generates a sine wave by way of frequency or phase modulation. In order to prepare the signal for transmission, an up-converter 1031 combines the sine wave output from the modulator 1027 with another sine wave generated by a synthesizer 1033 to achieve the desired frequency of transmission. The signal is then sent through a PA 1019 to increase the signal to an appropriate power level. In practical systems, the PA 1019 acts as a variable gain amplifier whose gain is controlled by the DSP 1005 from information received from a network base station. The signal is then filtered within the duplexer 1021 and optionally sent to an antenna coupler 1035 to match impedances to provide maximum power transfer. Finally, the signal is transmitted via antenna 1017 to a local base station. An automatic gain control (AGC) can be supplied to control the gain of the final stages of the receiver. The signals may be forwarded from there to a remote telephone which may be another cellular telephone, any other mobile phone or a land-line connected to a Public Switched Telephone Network (PSTN), or other telephony networks.

Voice signals transmitted to the mobile terminal 1001 are received via antenna 1017 and immediately amplified by a low noise amplifier (LNA) 1037. A down-converter 1039 lowers the carrier frequency while the demodulator 1041 strips away the RF leaving only a digital bit stream. The signal then goes through the equalizer 1025 and is processed by the DSP 1005. A Digital to Analog Converter (DAC) 1043 converts the signal and the resulting output is transmitted to the user through the speaker 1045, all under control of a Main Control Unit (MCU) 1003 which can be implemented as a Central Processing Unit (CPU) (not shown).

The MCU 1003 receives various signals including input signals from the keyboard 1047. The keyboard 1047 and/or the MCU 1003 in combination with other user input components (e.g., the microphone 1011) comprise a user interface circuitry for managing user input. The MCU 1003 runs a user interface software to facilitate user control of at least some functions of the mobile terminal 1001 to use scripts to utilize a service. The MCU 1003 also delivers a display command and a switch command to the display 1007 and to the speech output switching controller, respectively. Further, the MCU 1003 exchanges information with the DSP 1005 and can access an optionally incorporated SIM card 1049 and a memory 1051. In addition, the MCU 1003 executes various control functions required of the terminal. The DSP 1005 may, depending upon the implementation, perform any of a variety of conventional digital processing functions on the voice signals. Additionally, DSP 1005 determines the background noise level of the local environment from the signals detected by microphone 1011 and sets the gain of microphone 1011 to a level selected to compensate for the natural tendency of the user of the mobile terminal 1001.

The CODEC 1013 includes the ADC 1023 and DAC 1043. The memory 1051 stores various data including call incoming tone data and is capable of storing other data including music data received via, e.g., the global Internet. The software module could reside in RAM memory, flash memory, registers, or any other form of writable storage medium known in the art. The memory device 1051 may be, but not limited to, a single memory, CD, DVD, ROM, RAM, EEPROM, optical storage, magnetic disk storage, flash memory storage, or any other non-volatile storage medium capable of storing digital data.

An optionally incorporated SIM card 1049 carries, for instance, important information, such as the cellular phone number, the carrier supplying service, subscription details, and security information. The SIM card 1049 serves primarily to identify the mobile terminal 1001 on a radio network. The card 1049 also contains a memory for storing a personal telephone number registry, text messages, and user specific mobile terminal settings.

While the invention has been described in connection with a number of embodiments and implementations, the invention is not so limited but covers various obvious modifications and equivalent arrangements, which fall within the purview of the appended claims. Although features of the invention are expressed in certain combinations among the claims, it is contemplated that these features can be arranged in any combination and order.

1. A method comprising:
receiving a request specifying one or more tasks of a service with respect to a target object;
determining one or more scripts for performing the one or more tasks; and
determining to initiate the one or more scripts to use, at least in part, information associated with the target object to perform the one or more tasks.

2. A method of claim 1, wherein the one or more tasks relate to populating the information in one or more fields of a web page associated with the service, navigating the web page or a web site associated with the service, or a combination thereof.

3. A method of claim 2, wherein the one or more scripts execute concurrently with an application presenting the web page or the web site.

4. A method of claim 1, further comprising:
determining one or more conditions associated with the one or more scripts,
wherein the determining to initiate the one or more scripts is based, at least in part, on the one or more conditions.

5. A method of claim 4, wherein the one or more conditions relate to one or more event properties, a web page associated with the service, one or more script parameters, or a combination thereof.

6. A method of claim 4, wherein the one or more conditions relate to one or more privacy policies, one or more security policies, or a combination thereof.

7. A method of claim 1, further comprising:
determining one or more events during execution of the one or more scripts,
wherein the execution of the one or more scripts is based, at least in part, on the one or more events.

8. A method of claim 1, further comprising:
determining to present a cue to indicate execution of the one or more scripts.

9. A method of claim 1, wherein the one or more scripts initiates presentation of a prompt for the information, additional information, or a combination thereof.

10. A method of claim 1, further comprising:
determining to prompt a user to provide access of private data to the script.

11. An apparatus comprising:
at least one processor; and
at least one memory including computer program code for one or more programs,
the at least one memory and the computer program code configured to, with the at least one processor, cause the apparatus to perform at least the following,
receive a request specifying one or more tasks of a service with respect to a target object;
determine one or more scripts for performing the one or more tasks; and
determine to initiate the one or more scripts to use, at least in part, information associated with the target object to perform the one or more tasks.

12. An apparatus of claim 11, wherein the one or more tasks relate to populating the information in one or more fields of a web page associated with the service, navigating the web page or a web site associated with the service, or a combination thereof.

13. An apparatus of claim 12, wherein the one or more scripts execute concurrently with an application presenting the web page or the web site.

14. An apparatus of claim 11, wherein the apparatus is further caused to:
determine one or more conditions associated with the one or more scripts,
wherein the determining to initiate the one or more scripts is based, at least in part, on the one or more conditions.

15. An apparatus of claim 14, wherein the one or more conditions relate to one or more event properties, a web page associated with the service, one or more script parameters, or a combination thereof.

16. An apparatus of claim 14, wherein the one or more conditions relate to one or more privacy policies, one or more security policies, or a combination thereof.

17. An apparatus of claim 11, wherein the apparatus is further caused to:
determine one or more events during execution of the one or more scripts,
wherein the execution of the one or more scripts is based, at least in part, on the one or more events.

18. An apparatus of claim 11, wherein the apparatus is further caused to:
determine to present a cue to indicate execution of the one or more scripts.

19. An apparatus of claim 11, wherein the one or more scripts initiates presentation of a prompt for the information, additional information, or a combination thereof.

20. An apparatus of claim 11, wherein the apparatus is further caused to:
determine to prompt a user to provide access of private data to the script.

21.-46. (canceled)
